(19) United States
(12) Patent Application Publication
(10) Pub. No.: US 2024/0204851 A1
(43) Pub. Date: Jun. 20, 2024

(54) TECHNIQUES FOR DETERMINING COMMUNICATION PARAMETERS FOR BEAM SWITCHING

(71) Applicant: QUALCOMM INCORPORATED, San Diego, CA (US)

(72) Inventors: Fang Yuan, Beijing (CN); Yan Zhou, San Diego, CA (US); Tianyang Bai, Mountain View, CA (US); Tao Luo, San Diego, CA (US)

(21) Appl. No.: 18/554,975

(22) PCT Filed: Jun. 8, 2021
(86) PCT No.: PCT/CN2021/098791

§ 371 Date: Oct. 11, 2023

(51) Int. Cl. H04B 7/06; H04W 72/044; H04W 72/23

(52) U.S. Cl. CPC H04B 7/0686; H04W 72/046; H04W 72/23

(57) ABSTRACT

Techniques for wireless communications are described. A first device may communicate with a second device using a first beam. Based on communicating with the second device, the first device may indicate a reference signal associated with a different beam to indicate that the different beam associated with the reference signal is preferred for subsequent communications. The reporting device may switch to the different beam based on transmitting the indication of the reference signal. Based on switching to the different beam, the reporting device may determine a communication parameter based on the indicated reference signal and communicate with the scheduling device using the second beam based on the determined communication parameter.

### CROSS REFERENCE

The present Application is a 371 national stage filing of International PCT Application No. PCT/CN2021/098791 by Yuan et al. entitled “TECHNIQUES FOR DETERMINING COMMUNICATION PARAMETERS FOR BEAM SWITCHING,” filed Jun. 8, 2021, which is assigned to the assignee hereof, and which is expressly incorporated by reference in its entirety herein.

### FIELD OF DISCLOSURE

The following relates to wireless communications, including techniques for determining communication parameters for beam switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved techniques that support techniques for determining communication parameters for beam switching. A first device may communicate with a second device using a first beam. Based on communicating with the second device, the first device may indicate a reference signal associated with a different beam to indicate that the different beam associated with the reference signal is preferred for subsequent communications. The reporting device may switch to the different beam based on transmitting the indication of the reference signal. Based on switching to the different beam, the reporting device may determine a communication parameter based on the indicated reference signal and communicate with the scheduling device using the second beam based on the determined communication parameter.

A method for wireless communication at a user equipment (UE) is described. The method may include communicating with a base station using a first beam, transmitting, to the base station, an index of a reference signal associated with a second beam that is different from the first beam, switching to the second beam to communicate with the base station based on the index of the reference signal, determining, from the index of the reference signal, a communication parameter associated with the second beam, and communicating, based on the determined communication parameter, with the base station using the second beam.

An apparatus for wireless communication at a UE is described. The apparatus may include a processor, memory coupled with the processor, and instructions stored in the memory. The instructions may be executable by the processor to cause the apparatus to communicate with a base station using a first beam, transmit, to the base station, an index of a reference signal associated with a second beam that is different from the first beam, switch to the second beam to communicate with the base station based on the index of the reference signal, determine, from the index of the reference signal, a communication parameter associated with the second beam, and communicate, based on the determined communication parameter, with the base station using the second beam.

Another apparatus for wireless communication at a UE is described. The apparatus may include means for communicating with a base station using a first beam, means for transmitting, to the base station, an index of a reference signal associated with a second beam that is different from the first beam, means for switching to the second beam to communicate with the base station based on the index of the reference signal, means for determining, from the index of the reference signal, a communication parameter associated with the second beam, and means for communicating, based on the determined communication parameter, with the base station using the second beam.

A non-transitory computer-readable medium storing code for wireless communication at a UE is described. The code may include instructions executable by a processor to communicate with a base station using a first beam, transmit, to the base station, an index of a reference signal associated with a second beam that is different from the first beam, switch to the second beam to communicate with the base station based on the index of the reference signal, determine, from the index of the reference signal, a communication parameter associated with the second beam, and communicate, based on the determined communication parameter, with the base station using the second beam.

Some examples of the method, apparatuses, and non-transitory computer-readable medium described herein may further include operations, features, means, or instructions for receiving a message that activates a mode associated with the UE automatically switching to a new beam after indicating the new beam to the base station, where the UE switches to the second beam based on the mode being activated.

Some examples of the method, apparatuses, and non-transitory computer-readable medium described herein may further include operations, features, means, or instructions for receiving, based on communicating with the base station using the first beam, the reference signal using a transmission configuration indicator state.

In some examples of the method, apparatuses, and non-transitory computer-readable medium described herein, determining the communication parameter may include operations, features, means, or instructions for selecting, for receiving downlink communications from the base station, the transmission configuration indicator state used to receive the reference signal.

Some examples of the method, apparatuses, and non-transitory computer-readable medium described herein may further include operations, features, means, or instructions for determining a relationship between a first channel associated with the reference signal and a downlink control channel, a downlink shared channel, a second channel associated with a downlink reference signal, or any combination thereof, the relationship being based on common time and frequency characteristics, common spatial characteristics, or both.

In some examples of the method, apparatuses, and non-transitory computer-readable medium described herein, determining the communication parameter may include operations, features, means, or instructions for selecting a transmission configuration indicator state of the reference signal that indicates a spatial relationship between a first channel associated with the reference signal and a downlink control channel, a downlink shared channel, a second channel associated with a downlink reference signal, or any combination thereof.

Some examples of the method, apparatuses, and non-transitory computer-readable medium described herein may further include operations, features, means, or instructions for determining that a set of multiple transmission configuration indicator states of the reference signal indicate the spatial relationship and selecting the transmission configuration indicator state based on an index of the transmission configuration indicator state.

In some examples of the method, apparatuses, and non-transitory computer-readable medium described herein, determining the communication parameter may include operations, features, means, or instructions for selecting a transmission configuration indicator state of a second reference signal that indicates a spatial relationship between a first channel associated with the reference signal and a second channel associated with the second reference signal.

Some examples of the method, apparatuses, and non-transitory computer-readable medium described herein may further include operations, features, means, or instructions for determining that a set of multiple transmission configuration indicator states of the second reference signal indicate the spatial relationship and selecting the transmission configuration indicator state based on an index of the transmission configuration indicator state.

In some examples of the method, apparatuses, and non-transitory computer-readable medium described herein, determining the communication parameter may include operations, features, means, or instructions for determining a spatial relationship between a first channel of the reference signal and a downlink control channel, a downlink shared channel, a second channel associated with a downlink reference signal, or any combination thereof.

In some examples of the method, apparatuses, and non-transitory computer-readable medium described herein, determining the communication parameter may include operations, features, means, or instructions for determining a relationship between the first channel of the reference signal and a third channel of a synchronization and signal block and determining a time and frequency relationship between the third channel of the synchronization and signal block and the downlink control channel, the downlink shared channel, the second channel associated with the downlink reference signal, or any combination thereof.

In some examples of the method, apparatuses, and non-transitory computer-readable medium described herein, determining the communication parameter may include operations, features, means, or instructions for determining a relationship between the first channel of the reference signal and a third channel of a periodic channel state information reference signal and determining a time and frequency relationship between the third channel of the periodic channel state information reference signal and the downlink control channel, the downlink shared channel, the second channel associated with the downlink reference signal, or any combination thereof.

In some examples of the method, apparatuses, and non-transitory computer-readable medium described herein, the second beam may be a downlink beam.

In some examples of the method, apparatuses, and non-transitory computer-readable medium described herein, determining the communication parameter may include operations, features, means, or instructions for selecting a latest set of power control parameters used for an uplink channel associated with the second beam, a latest parameter of pathloss reference signal used for the uplink channel, or both.

Some examples of the method, apparatuses, and non-transitory computer-readable medium described herein may further include operations, features, means, or instructions for receiving, in control signaling and prior to switching to the second beam, a set of power control parameters associated with an uplink channel associated with the second beam and where determining the communication parameter includes selecting the set of power control parameters.

In some examples of the method, apparatuses, and non-transitory computer-readable medium described herein, determining the communication parameter may include operations, features, means, or instructions for selecting a default set of power control parameters, a default parameter of a pathloss reference signal, or both.

Some examples of the method, apparatuses, and non-transitory computer-readable medium described herein may further include operations, features, means, or instructions for selecting a transmission configuration indicator state based on the index of the reference signal, where determining the communication parameter includes selecting a parameter of a pathloss reference signal based on the transmission configuration indicator state.

In some examples of the method, apparatuses, and non-transitory computer-readable medium described herein, the pathloss reference signal may be periodic, and a first channel of the reference signal may have a relationship with a channel of the pathloss reference signal.

In some examples of the method, apparatuses, and non-transitory computer-readable medium described herein, the second beam may be an uplink beam.

In some examples of the method, apparatuses, and non-transitory computer-readable medium described herein, determining the communication parameter may include operations, features, means, or instructions for determining a transmission configuration indicator state based on the reference signal.

In some examples of the method, apparatuses, and non-transitory computer-readable medium described herein, determining the communication parameter may include operations, features, means, or instructions for determining a power control parameter or pathloss reference signal configuration based on the reference signal.

### BRIEF DESCRIPTION OF THE DRAWINGS

FIG. 1 illustrates an example of a wireless communications system that supports techniques for determining communication parameters for beam switching in accordance with various aspects of the present disclosure.

FIG. 2 illustrates an example of a wireless communications subsystem that supports techniques for determining communication parameters for beam switching in accordance with various aspects of the present disclosure.

FIG. 3 illustrates an example of a set of operations that supports techniques for determining communication parameters for beam switching in accordance with various aspects of the present disclosure.

FIGS. 4 and 5 show block diagrams of devices that support techniques for determining communication parameters for beam switching in accordance with various aspects of the present disclosure.

FIG. 6 shows a block diagram of a communications manager that supports techniques for determining communication parameters for beam switching in accordance with various aspects of the present disclosure.

FIG. 7 shows a diagram of a system including a device that supports techniques for determining communication parameters for beam switching in accordance with various aspects of the present disclosure.

FIGS. 8 through 10 show flowcharts illustrating methods that support techniques for determining communication parameters for beam switching in accordance with various aspects of the present disclosure.

### DETAILED DESCRIPTION

Devices used for communications (e.g., a user equipment (UE), a base station, etc.) may communicate with one another using beamformed communications. In some examples, a beam (e.g., downlink beam, uplink beam, etc.) over which transmissions between the devices have preferred signal characteristics may be selected for communications between the devices. To determine a preferred beam for communications between the devices, a first device (which may also be referred to as a “reporting device”) may report, to a second device (which may also be referred to as a “scheduling device”), one or more of an indication of the preferred beam (e.g. a reference signal (RS) index) or measurements associated with signals received over multiple beams that support communications between the devices.

In some examples, the scheduling device may use the information reported by the reporting device to select a beam for communicating with the reporting device, where the selected beam may be the same or different than a preferred beam indicated by the reporting device. Based on selecting the beam, the scheduling device may transmit a message to the reporting device indicating that the beam has been selected. In other examples, the scheduling device may automatically use the beam indicated by the reporting device for subsequent communications with the reporting device, and the reporting device may automatically configure its equipment for communications over the indicated beam. Autonomously switching, by the devices, to a new beam (without additional signaling being exchanged) may be referred to as “implicit beam switching.”

When implicit beam switching is used, information associated with using a new beam to receive downlink communications (e.g., quasi-colocation information), information associated with using a new beam to transmit uplink communications (e.g., power control information, pathloss reference signal configurations), or both, may not be communicated to a reporting device. That is, information that would otherwise be included by a scheduling device in an indication that a new beam has been selected may not be transmitted to the reporting device. Thus, the reporting device may be unable to reliably receive downlink communications from the scheduling device using a new beam—e.g., based on being unable to determine a quasi-colocation relationship for a reference signal included in the downlink communication. Also, the reporting device may be unable to reliably transmit uplink communications to the scheduling device using a new beam—e.g., based on being unable to determine power control parameters, a pathloss reference signal configuration, or both, for the uplink communications.

To increase a reliability of communications when implicit beam switching is used, enhanced procedures for identifying downlink communication parameters (e.g., quasi-colocation information) and uplink communication parameters (e.g., power control information, pathloss reference signal configurations) based on a selected beam may be used. In some examples, a reporting device (e.g., a UE) may communicate with a scheduling device (e.g., a base station) using a first beam. Based on communicating with the scheduling device, the reporting device may indicate a reference signal (e.g., using an index of the reference signal) associated with a different beam—e.g., based on determining that characteristics of the reference signal are superior to characteristics of a reference signal associated with the current beam. The indication of the reference signal may indicate that a beam associated with the reference signal is preferred for subsequent communications. The reporting device may switch to the different beam based on transmitting the indication of the reference signal—e.g., either automatically or based on receiving, from the scheduling device, an indication that the different beam has been selected for subsequent communications. Based on switching to the different beam, the reporting device may determine a communication parameter (e.g., a downlink or uplink communication parameter) based on the indicated reference signal and communicate with the scheduling device using the second beam based on the determined communication parameter.

By using the indicated reference signal to determine communication parameters when implicit beam switching is used, a reporting device may be able to determine communications parameters for a selected beam without receiving any beam switching indication for the selected beam from the scheduling device, reducing signaling overhead and enabling implicit beam switching. By using the indicated reference signal to determine communication parameters when explicit beam switching is used, a reporting device may be able to determine communications parameters for a selected beam while receiving an indication of the selected beam (but without receiving an explicit indication of the communication parameters for the selected beam) from the scheduling device, reducing signaling overhead associated with beam switching.

Aspects of the disclosure are initially described in the context of wireless communications systems. Aspects of the disclosure are also described in the context of a process flow: Aspects of the disclosure are further illustrated by and described with reference to apparatus diagrams, system diagrams, and flowcharts that relate to techniques for determining communication parameters for beam switching.

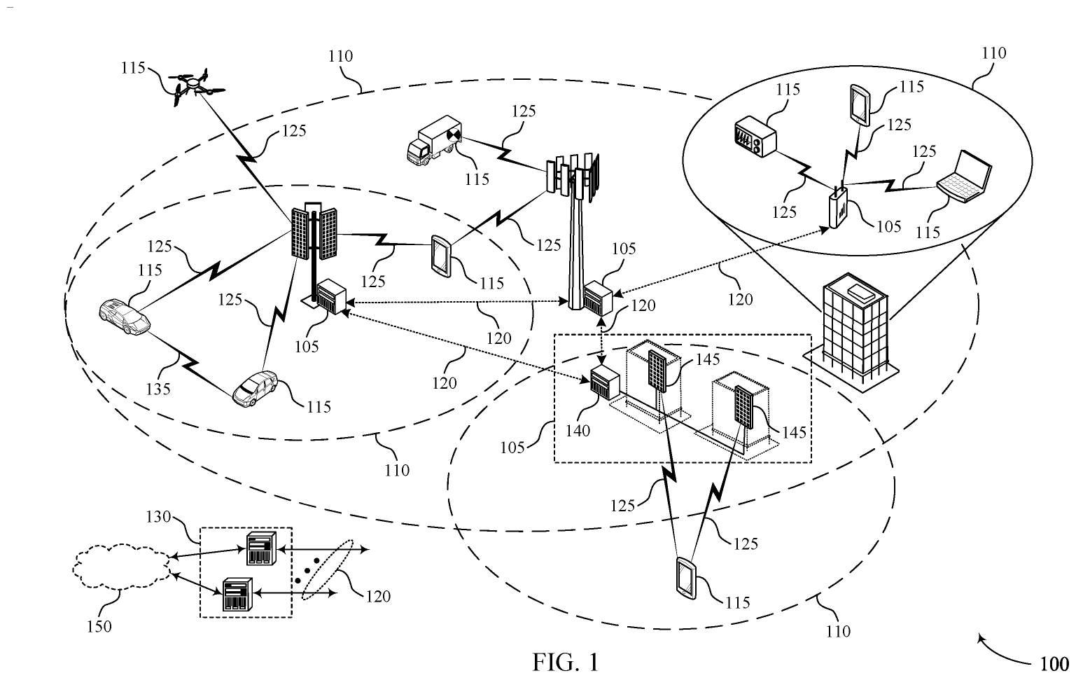

FIG. 1 illustrates an example of a wireless communications system 100 that supports techniques for determining communication parameters for beam switching in accordance with various aspects of the present disclosure. The wireless communications system 100 may include one or more base stations 105, one or more UEs 115, and a core network 130. In some examples, the wireless communications system 100 may be a Long-Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or another interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHZ.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

A base station 105 may use beamformed transmissions to communicate with UEs 115. In some examples, to determine a beam (an uplink beam, downlink beam, or both) for communicating with a UE 115, a beam sweeping procedure may be performed. A beam sweeping procedure may include transmitting, from a base station 105, synchronization and reference signals in different directions (that is, in different beams) using multiple synchronization signal blocks (SSBs), where each SSB may be associated with a different beam. Based on the beam sweeping procedure, a UE 115 may determine a preferred beam (an uplink beam, downlink beam, or both) for communicating with the base station 105—e.g., the beam carrying the reference signals that are received at the UE 115 with the highest signal quality. The UE 115 may also indicate the preferred beam to base station 105—e.g., by including an index of the SSB associated with the preferred beam. The base station 105 may select a beam for communicating with the UE 115 based on the indication from the UE 115, where the beam may be the same or different than the preferred beam indicated by the UE 115.

In some examples, the base station 105 may also configure the UE 115 with a set of channel state information reference signal (CSI-RS) resources associated with the beam used to communicate with UE 115. In some examples, each CSI-RS resource has an index and is associated with a different beam that may be used to communicate with UE 115. The UE 115 may report (e.g., in a channel state information (CSI) report), an index of the CSI-RS resource associated with the highest signal quality, where the index of CSI-RS resource may correspond to a preferred beam for the UE 115.

In some examples, the base station 105 may use the measurements reported for the CSI-RS resources to determine a beam (an uplink beam, downlink beam, or both) to use for the UE 115 for subsequent communications. In some examples, the base station 105 selects, for subsequent communications to the UE 115, a different beam than the beam currently being used to serve the UE 115. The base station 105 may indicate to the UE 115 that a new beam has been selected for communicating with the UE 115. In some examples, the base station may also indicate a transmission configuration (e.g., using a transmission configuration indicator (TCI)) that indicates quasi-colocation (QCL) relationships between a CSI-RS resource associated with the new beam and reference signal resources included in subsequent transmissions to the UE 115. Also, the base station 105 may indicate spatial relationship information that indicates power control parameters for uplink transmissions by UE 115.

In some examples, there are multiple types of QCL relationships that may exist between signals. For example, a QCL-Type A relationship may indicate that a channel of a first reference signal has similar Doppler shift, Doppler spread, average delay, and delay spread parameters as a control channel, shared channel, channel of another reference signal, or any combination thereof. A QCL-Type B relationship may indicate that a channel of a first reference signal has similar Doppler shift and Doppler spread parameters as a control channel, shared channel, channel of another reference signal, or any combination thereof. A QCL-Type C relationship may indicate that a channel of a first reference signal has similar average delay and Doppler spread parameters as a control channel, shared channel, channel of another reference signal, or any combination thereof. And a QCL-Type D relationship may indicate that a channel of a first reference signal has similar spatial reception parameters as a control channel, shared channel, channel of another reference signal, or any combination thereof.

In other examples, the base station 105 may perform subsequent communications to the UE 115 using the beam (an uplink beam, downlink beam, or both) associated with a reported CSI-RS resource, and the UE 115 may reconfigure its reception parameters for the preferred beam based on indicating the preferred beam to the base station 105. In such cases, the base station 105 may not indicate to the UE 115 that a new beam has been selected for communicating with the UE 115, reducing overhead. Autonomously switching, by the base station 105 and UE 115, to a new beam (without additional signaling being exchanged) may be referred to as implicit beam switching.

When implicit beam switching is used, information associated with using a new beam to receive downlink communications (e.g., quasi-colocation information), information associated with using a new beam to transmit uplink communications (e.g., power control information), or both, may not be communicated to a UE 115. That is, information that would otherwise be included by a base station 105 in an indication that a new beam has been selected may not be transmitted to the UE 115. Thus, a UE 115 may be unable to reliably receive downlink communications from the base station 105 using a new beam—e.g., based on being unable to determine a quasi-colocation relationship for a reference signal included in the downlink communication. Also, a UE 115 may be unable to reliably transmit uplink communications to the base station 105 using a new beam—e.g., based on being unable to determine power control parameters for the uplink communications.

To increase a reliability of communications when implicit beam switching is used, enhanced procedures for identifying downlink communication parameters (e.g., quasi-colocation information) and uplink communication parameters (e.g., power control information, pathloss reference signal configurations) based on a selected beam may be used. In some examples, a UE 115 may communicate with a base station 105 using a first beam. Based on communicating with the base station 105, the UE 115 may indicate a reference signal (e.g., using an index of the reference signal) associated with a different beam—e.g., based on determining that characteristics of the reference signal are superior to characteristics of a reference signal associated with the current beam. The indication of the reference signal may indicate that a beam associated with the reference signal is preferred for subsequent communications. The UE 115 may switch to the different beam based on transmitting the indication of the reference signal—e.g., either automatically or based on receiving, from the base station 105, an indication that the different beam has been selected for subsequent communications. Based on switching to the different beam, the UE 115 may determine a communication parameter (e.g., a downlink or uplink communication parameter) based on the indicated reference signal and communicate with the base station 105 using the second beam based on the determined communication parameter.

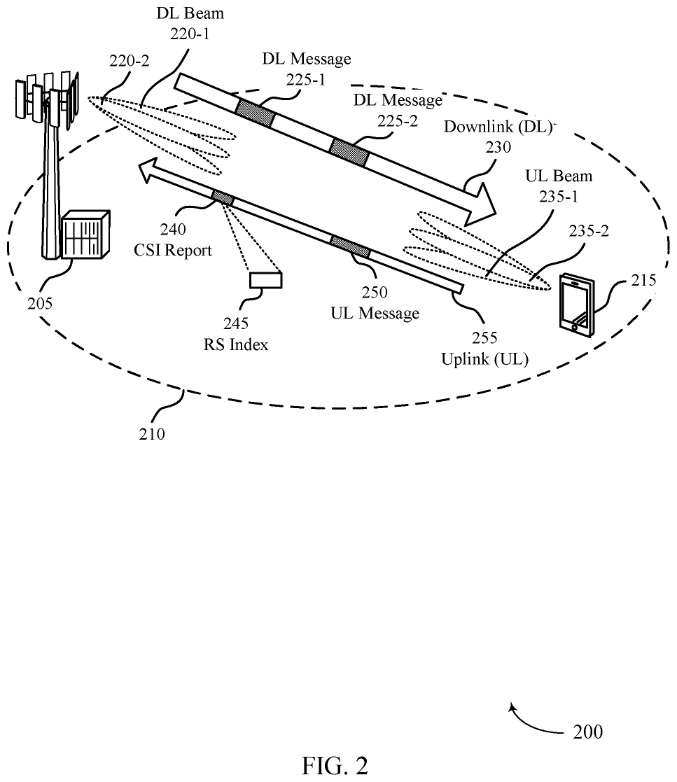

FIG. 2 illustrates an example of a wireless communications subsystem that supports techniques for determining communication parameters for beam switching in accordance with various aspects of the present disclosure.

Wireless communications subsystem 200 may include base station 205 and UE 215, which may be respective examples of a base station and UE described with reference to FIG. 1. Base station 205 and UE 215 may communicate with one another within coverage area 210 using one or more of the techniques described with reference to FIG. 1.

Base station 205 may communicate with UEs within coverage area 210 (including UE 215) using downlink beams 220. The energy of signals transmitted in a downlink beam 220 may be focused in a direction and may cover a portion of coverage area 210. In some examples, multiple downlink beams 220 pointed in different directions may provide full coverage for coverage area 210. Similarly, UE 215 may communicate with base station 205 using uplink beams 235 via uplink 255.

In some examples, base station 205 transmits first downlink message 225-1 to UE 215 using downlink 230 using first downlink beam 220-1. In some examples, base station 205 and UE 215 may select first downlink beam 220-1 during a beam sweeping procedure. UE 215 may receive first downlink message 225-1 via downlink 230. UE 215 may also receive one or more reference signals (RSs), such as SSBs, CSI-RSs, etc., via downlink 230.

In some examples, UE 215 may determine that a different beam (e.g., second downlink beam 220-2) is preferred for communications with base station 205—e.g., based on the one or more reference signals. In some examples, UE 215 may determine that second downlink beam 220-2 is preferred based on receiving a reference signal associated with (e.g., spatially quasi-colocated with) second downlink beam 220-2. Based on determining that second downlink beam 220-2 is preferred, UE 215 may indicate a preference for second downlink beam 220-2 to base station 205. To indicate the preference for second downlink beam 220-2, UE 215 may include an index associated with second downlink beam 220-2 (e.g., RS index 245) in CSI report 240. The CSI report 240 may be preconfigured for implicit beam switching purpose.

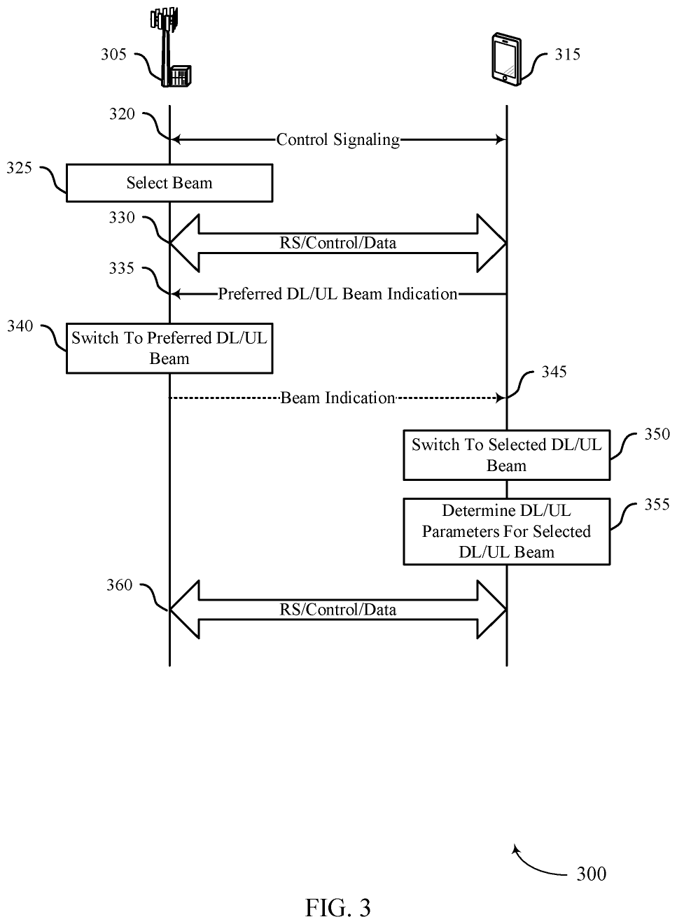

In some examples, UE 215 may be operating in an implicit beam switching mode. In such cases, UE 215 may automatically reconfigure itself for receiving over second downlink beam 220-2 indicated in CSI report 240. Also, base station 205 may automatically use second downlink beam 220-2 for transmitting to UE 215. While an implicit beam switching mode is activated, UE 215 may not receive a further indication from base station 205 that second downlink beam 220-2 has been selected for communications to UE 215. Accordingly, UE 215 may determine communication parameters for receiving communications from base station 205 using second downlink beam 220-2 based on RS index 245 after some time offset from the CSI report 240. The communications parameters may include a TCI state, QCL relationships, or both. Operations associated with determining the communication parameters for downlink transmission are described in more detail herein including with reference to FIG. 3.

In other examples, UE 215 may be operating in an explicit beam switching mode. In such cases, UE 215 may not reconfigure itself for receiving over second downlink beam 220-2 until an indication is received from base station 205 that second downlink beam 220-2 has been selected. In such cases, UE 215 may similarly determine communication parameters for receiving communications from base station 205 using second downlink beam 220-2 based on RS index 245—e.g., if base station 205 does not include the communication parameters in the indication.

Based on receiving CSI report 240, base station 205 may transmit second downlink message to UE 215 using second downlink beam 220-2. And UE 215 may use the determined downlink communication parameters to receive the second downlink message 225-2.

UE 215 may similarly determine that second uplink beam 235-2 is preferred for communicating with base station 205 over first uplink beam 235-1—e.g., based on one or more uplink reference signals. In some examples, UE 215 indicates a preference for second uplink beam 235-2 in CSI report 240, or a different CSI report. In some examples, UE 215 indicates a reference signal index associated with second uplink beam 235-2 in CSI report 240. As similarly described herein, UE 215 may be configured in either an implicit or explicit beam switching mode, and in both cases, may determine communication parameters for transmitting communications to base station 205 using second uplink beam 235-2 based on the indicated reference signal index, an uplink channel associated with the indicated reference signal index, or both after some time offset from the CSI report 240. Operations associated with determining the communication parameters for uplink transmission are described in more detail herein including with reference to FIG. 3.

Based on indicating a preference for second uplink beam 235-2, UE 215 may transmit uplink message 250 to base station 205 using second uplink beam 235-2 and the determined uplink communication parameters.

FIG. 3 illustrates an example of a set of operations that supports techniques for determining communication parameters for beam switching in accordance with various aspects of the present disclosure.

Process flow 300 may be performed by base station 305 and UE 315, which may be respective examples of a base station or UE described with reference to FIG. 1 or 2. In some examples, process flow 300 illustrates an exemplary sequence of operations performed to support determining communication parameters for beam switching. For example, process flow 300 depicts operations for determining downlink communication parameters and uplink communication parameters for communicating over a preferred beam based on a reference signal associated with the preferred beam.

It is understood that one or more of the operations described in process flow 300 may be performed earlier or later in the process, omitted, replaced, supplemented, or combined with another operation. Also, additional operations described herein that are not included in process flow 300 may be included.

At arrow 320, control signaling (e.g., radio resource control (RRC) signaling) may be exchanged between base station 305 and UE 315. In some examples, the control signaling may be used to activate a beam switching mode (e.g., an explicit beam switching mode or an implicit beam switching mode). In some examples, the control signaling may be used to activate a mode at UE 315 associated with determining communication parameters based on a reference signal associated with a preferred beam.

At block 325, base station 305 may select a beam for communicating with UE 315. In some examples, base station 305 may select the beam based at least in part on a beam sweeping procedure, and a preferred beam indicated by UE 315. In some examples, base station 305 may select a downlink beam for communications to UE 315 and an uplink beam for communications from UE 315.

At arrow 330, base station 305 may transmit reference signals, control information, and data to UE 315. Also, UE 315 may transmit reference signals, control information, and data to base station 305. In some examples, UE 315 may determine a preferred (uplink or downlink) beam for communicating with base station 305 that is different than the (uplink or downlink) beam currently being used for communications between base station 305 and UE 315. In some examples, UE 315 determines the preferred beam based on a location of UE 315 being changed or a blockage entering a communicative path between base station 305 and UE 315. In some examples, the reference signals (e.g., SSBs, CSI-RSs, etc.) communicated between base station 305 and UE 315 may be associated with indices.

To determine the preferred beam, UE 315 may measure signal characteristics of one or more reference signals. In some examples, UE 315 may determine that the signal characteristics associated with a reference signal associated with the preferred beam are better than the signal characteristics associated with a reference signal associated with the current beam. The reference signal may be associated with an index. In some examples, UE 315 may receive the one or more reference signals using different TCI states.

At arrow 335, UE 315 may indicate the index of the reference signal to base station 305 to indicate a preference for the preferred beam (which may also be referred to as the reported beam). In some examples, the index of the reference signal is included in a CSI report.

At block 340, base station 305 may switch to a new beam. In some examples, base station 305 switches to the reported beam. In some examples, base station 305 determines whether to switch to the reported beam before switching to the reported beam (e.g., if an explicit beam switching mode is activated). In other examples, base station 305 automatically switches to the reported beam (e.g., if an implicit beam switching mode is activated).

At arrow 345, base station 305 may indicate the selected beam to UE 315—e.g., if the explicit beam switching mode is activated. In some examples, the selected beam is the same as the beam reported by UE 315. In some examples, base station 305 may indicate the selection of a different beam than the reported beam. In some examples, when base station 305 indicates the selection of the different beam, the indication also includes communication parameters associated with the different beam (e.g., TCI state or power control parameters).

In some examples, when implicit beam switching is used, base station 305 may send a message to UE 315 directing UE 315 to continue using the current beam. In such cases, UE 315 may not switch to the reported beam.

At block 350, UE 315 may switch to the selected beam for subsequent communications with base station 305. When an implicit beam switching mode is enabled, UE 315 may automatically switch to the reported beam based on reporting the preferred beam to base station 305. When an explicit beam switching mode is enabled, UE 315 may switch to the beam indicated by base station 305 (which may be the same as or different than the reported beam).

At block 355, UE 315 may determine communication parameters for communicating with base station 305 using the selected beam (e.g., the reported beam or a different beam selected by base station 305 based on the selected reference signal in the CSI report 240). In some examples, UE 315 may determine the communication parameters based on the reference signal associated with the reported beam. In some examples, UE 315 may determine the communication parameters based on a reference signal associated with a beam indicated by base station 305 that is different than the reported beam—e.g., if base station 305 indicates a different beam.

In some examples, for a downlink beam, UE 315 may determine a TCI state for receiving communications over the selected beam. A first option for determining the TCI state used for communications over the selected beam may include selecting a TCI state that is the same as the TCI state used to receive the reference signal associated with the selected reference signal in the CSI report. In some examples, a channel estimation relationship (e.g., a QCL-Type A relationship) between a reference signal associated with the TCI state and subsequent reference signals and channels received from base station 305 using the selected beam may be determined based on the TCI state. Additionally, or alternatively, a spatial relationship (e.g., a QCL-Type D relationship) between a reference signal associated with the TCI state and subsequent reference signals and channels received from base station 305 using the selected beam may be determined based on the TCI state. When the UE 315 selects and reports a reference signal index in a CSI report that is used for an implicit beam switching. UE may determine a TCI state to be applied for target channels/reference signals based on the TCI state used for the reception of the selected reference signal in a CSI report.

A second option for determining the TCI state used to receive communications over the selected beam may include identifying a TCI state for the selected reference signal (e.g., based on the index of the reference signal) that has a spatial relationship with subsequent reference signals and channel received from base station 305 using the selected beam. In some examples, there are multiple TCI states for the selected reference signal that have the spatial relationship. In such cases, the TCI state may be selected based on the indices of the TCI state. For example, the TCI state with the lowest index may be selected. When the UE 315 selects and reports a reference signal index in a CSI report that is used for an implicit beam switching, UE may determine a TCI state to be switched on for target channels/reference signals based on the TCI state which has the selected reference signal serving a source references for QCL reference signal where the QCL reference signal may be a QCL-type D reference signal or a QCL-type A reference signal. If there are multiple TCIs having the selected reference signal as a QCL reference signal, the UE 315 may select one of them by a rule, e.g., by lowest TCI ID.

A third option for determining the TCI state used to receive communications over the selected beam may include identifying a TCI state for another reference signal (e.g., based on the index of the reference signal) that has a spatial relationship with the selected reference signal. In some examples, there are multiple TCI states for the selected reference signal that have the spatial relationship. In such cases, the TCI state may be selected based on the indices of the TCI state. For example, the TCI state with the lowest index may be selected. When the UE 315 selects and reports a reference signal index in a CSI report that is used for an implicit beam switch, the UE 315 may determine a TCI state to be switched on for target channels/reference signals based on the TCI state which has a source reference signal quasi collocated (QCLed) to the selected reference signal in the CSI report. If there are multiple TCIs having the source reference signal QCLed to the selected reference signal, the UE 315 may select one of them by a rule, e.g., by lowest TCI ID.

A fourth option for determining the TCI state used to receive communications over the selected beam may include assuming a spatial relationship between the selected reference signal and subsequent reference signals and channel received from base station 305 using the selected beam. In some examples, a channel estimation relationship (e.g., a QCL-Type C relationship) is determined based on an SSB that is quasi-colocated with the selected reference signal in the CSI report. Additionally, or alternatively, a channel estimation relationship (e.g., a QCL-Type A relationship) is determined based on a periodic CSI-RS that is quasi-colocated with the selected reference signal in the CSI report, e.g., a tracking reference signal.

In some examples, for an uplink beam, UE 315 may determine power control parameters (e.g., a PO parameter, an alpha parameter, a close loop index, etc.), a pathloss reference signal configuration, or both, for receiving communications over the selected beam. A first option for determining the power control parameters, pathloss reference signal configuration, or both, may include reusing the latest power control parameters, pathloss reference signal configuration, or both, for an uplink channel of the selected beam—e.g., based on a prior set of power control parameters, pathloss configuration, or both, used for the uplink channel. Another option for determining the power control parameters, pathloss reference signal configuration, or both, may include using the latest power control parameters, pathloss reference signal configuration, or both, used for an uplink channel of the current beam.

A second option for determining the power control parameters may include using a set of power control parameters received for an uplink channel of the selected beam—e.g., in radio resource control signaling. For example, the first configured values of PO, alpha, close loop index may be used for the uplink channels applicable with the spatial filter determined based on the selected reference signal in the CSI report.

A third option determining the power control parameters, pathloss reference signal configuration, or both, may include using default parameters for uplink power control. In such cases, the power control parameters may be considered missing, and default parameters programmed at UE 315 may be identified. The UE may use the default configured values of PO, alpha, close loop index for the uplink transmissions applicable with the spatial filter determined based on the selected reference signal in the CSI report.

A fourth option for determining a pathloss reference signal configuration may include determining the pathloss reference signal configuration based on a TCI state selected for receiving downlink communications, where the TCI state may be determined as described herein. In some examples, the pathloss reference signal configuration may be a periodic reference signal that is quasi-colocated with the selected reference signal indicated by UE 315.

At arrow 360, base station 305 and UE 315 may exchange communicate information with one another using the selected beam. In some examples, UE 315 may use the determined TCI state to receive (e.g., decode) communications from base station 305 and the determined power control parameters, pathloss reference signal configuration, or both, to transmit communications to base station 305.

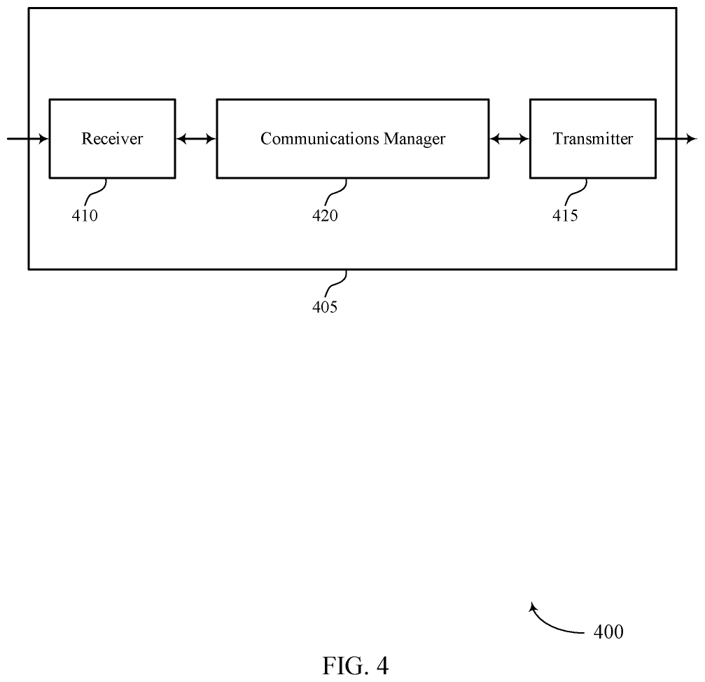

FIG. 4 shows a block diagram of a device that supports techniques for determining communication parameters for beam switching in accordance with various aspects of the present disclosure. Block diagram 400 may include the device 405, which may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for determining communication parameters for beam switching). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for determining communication parameters for beam switching). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for determining communication parameters for beam switching as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a UE in accordance with examples as disclosed herein. For example, the communications manager 420 may be configured as or otherwise support a means for communicating with a base station using a first beam. The communications manager 420 may be configured as or otherwise support a means for transmitting, to the base station, an index of a reference signal associated with a second beam that is different from the first beam. The communications manager 420 may be configured as or otherwise support a means for switching to the second beam to communicate with the base station based on the index of the reference signal. The communications manager 420 may be configured as or otherwise support a means for determining, from the index of the reference signal, a communication parameter associated with the second beam. The communications manager 420 may be configured as or otherwise support a means for communicating, based on the determined communication parameter, with the base station using the second beam.

By including or configuring the communications manager 420 in accordance with examples as described herein, the device 405 (e.g., a processor controlling or otherwise coupled to the receiver 410, the transmitter 415, the communications manager 420, or a combination thereof) may support techniques determining communications parameters for a selected beam without receiving any beam switching indication (or with less beam switching signaling for the selected beam from the scheduling device, reducing signaling overhead and increasing system throughput.

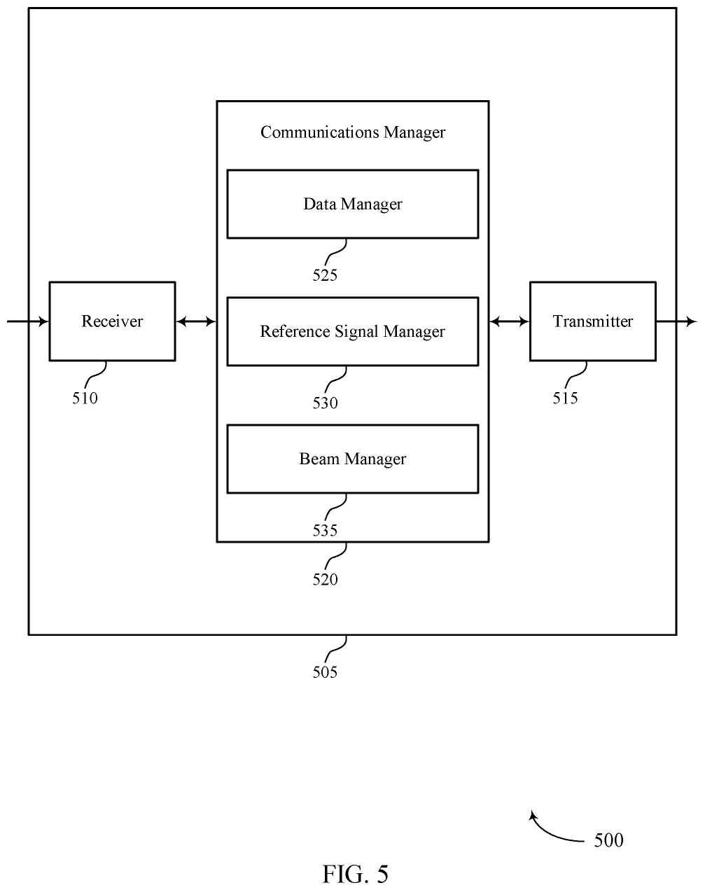

FIG. 5 shows a block diagram of a device that supports techniques for determining communication parameters for beam switching in accordance with various aspects of the present disclosure. Block diagram 500 may include the device 505, which may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for determining communication parameters for beam switching). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for determining communication parameters for beam switching). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for determining communication parameters for beam switching as described herein. For example, the communications manager 520 may include a data manager 525, a reference signal manager 530), a beam manager 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. The data manager 525 may be configured as or otherwise support a means for communicating with a base station using a first beam. The reference signal manager 530 may be configured as or otherwise support a means for transmitting, to the base station, an index of a reference signal associated with a second beam that is different from the first beam. The beam manager 535 may be configured as or otherwise support a means for switching to the second beam to communicate with the base station based on the index of the reference signal. The data manager 525 may be configured as or otherwise support a means for determining, from the index of the reference signal, a communication parameter associated with the second beam. The data manager 525 may be configured as or otherwise support a means for communicating, based on the determined communication parameter, with the base station using the second beam.

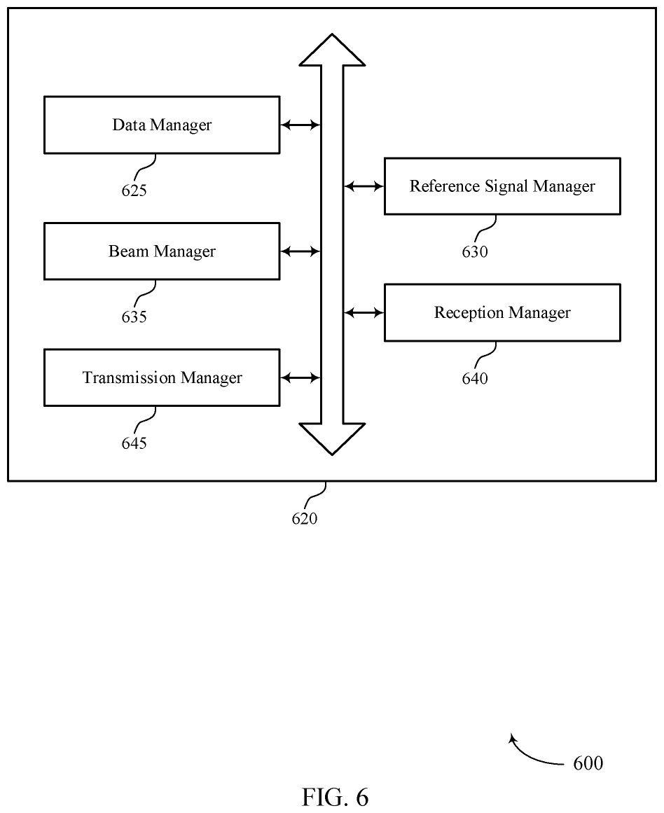

FIG. 6 shows a block diagram of a communications manager that supports techniques for determining communication parameters for beam switching in accordance with various aspects of the present disclosure. Block diagram 600 may include the communications manager 620, which may be an example of aspects of a communications manager 420, a communications manager 520, or both, as described herein. The communications manager 620, or various components thereof, may be an example of means for performing various aspects of techniques for determining communication parameters for beam switching as described herein. For example, the communications manager 620 may include a data manager 625, a reference signal manager 630, a beam manager 635, a reception manager 640, a transmission manager 645, or any combination thereof. Each of these components may communicate, directly or indirectly, with one another (e.g., via one or more buses).

The communications manager 620 may support wireless communication at a UE in accordance with examples as disclosed herein. The data manager 625 may be configured as or otherwise support a means for communicating with a base station using a first beam. The reference signal manager 630 may be configured as or otherwise support a means for transmitting, to the base station, an index of a reference signal associated with a second beam that is different from the first beam. The beam manager 635 may be configured as or otherwise support a means for switching to the second beam to communicate with the base station based on the index of the reference signal. In some examples, the data manager 625 may be configured as or otherwise support a means for determining, from the index of the reference signal, a communication parameter associated with the second beam. In some examples, the data manager 625 may be configured as or otherwise support a means for communicating, based on the determined communication parameter, with the base station using the second beam.

In some examples, to support determining the communication parameter, the reception manager 640 may be configured as or otherwise support a means for determining a transmission configuration indicator state based on the reference signal. In some examples, the second beam is a downlink beam.

In some examples, the reference signal manager 630 may be configured as or otherwise support a means for receiving, based on communicating with the base station using the first beam, the reference signal using a transmission configuration indicator state.

In some examples, to support determining the communication parameter, the reception manager 640 may be configured as or otherwise support a means for selecting, for receiving downlink communications from the base station, the transmission configuration indicator state used to receive the reference signal.

In some examples, the reception manager 640 may be configured as or otherwise support a means for determining a relationship between a first channel associated with the reference signal and a downlink control channel, a downlink shared channel, a second channel associated with a downlink reference signal, or any combination thereof, the relationship being based on common time and frequency characteristics, common spatial characteristics, or both.

In some examples, to support determining the communication parameter, the reception manager 640 may be configured as or otherwise support a means for selecting a transmission configuration indicator state of the reference signal that indicates a spatial relationship between a first channel associated with the reference signal and a downlink control channel, a downlink shared channel, a second channel associated with a downlink reference signal, or any combination thereof.

In some examples, the reception manager 640 may be configured as or otherwise support a means for determining that a set of multiple transmission configuration indicator states of the reference signal indicate the spatial relationship. In some examples, the reception manager 640 may be configured as or otherwise support a means for selecting the transmission configuration indicator state based on an index of the transmission configuration indicator state.

In some examples, to support determining the communication parameter, the reception manager 640 may be configured as or otherwise support a means for selecting a transmission configuration indicator state of a second reference signal that indicates a spatial relationship between a first channel associated with the reference signal and a second channel associated with the second reference signal.

In some examples, the reception manager 640 may be configured as or otherwise support a means for determining that a set of multiple transmission configuration indicator states of the second reference signal indicate the spatial relationship. In some examples, the reception manager 640 may be configured as or otherwise support a means for selecting the transmission configuration indicator state based on an index of the transmission configuration indicator state.

In some examples, to support determining the communication parameter, the reception manager 640 may be configured as or otherwise support a means for determining a spatial relationship between a first channel of the reference signal and a downlink control channel, a downlink shared channel, a second channel associated with a downlink reference signal, or any combination thereof.

In some examples, to support determining the communication parameter, the reception manager 640 may be configured as or otherwise support a means for determining a relationship between the first channel of the reference signal and a third channel of a synchronization signal block. In some examples, to support determining the communication parameter, the reception manager 640 may be configured as or otherwise support a means for determining a time and frequency relationship between the third channel of the synchronization signal block and the downlink control channel, the downlink shared channel, the second channel associated with the downlink reference signal, or any combination thereof.

In some examples, to support determining the communication parameter, the reception manager 640 may be configured as or otherwise support a means for determining a relationship between the first channel of the reference signal and a third channel of a periodic channel state information reference signal. In some examples, to support determining the communication parameter, the reception manager 640 may be configured as or otherwise support a means for determining a time and frequency relationship between the third channel of the periodic channel state information reference signal and the downlink control channel, the downlink shared channel, the second channel associated with the downlink reference signal, or any combination thereof.

In some examples, to support determining the communication parameter, the transmission manager 645 may be configured as or otherwise support a means for determining a power control parameter or pathloss reference signal configuration based on the reference signal. In some examples, the second beam is an uplink beam.

In some examples, to support determining the communication parameter, the transmission manager 645 may be configured as or otherwise support a means for selecting a latest set of power control parameters used for an uplink channel associated with the second beam, a latest parameter of pathloss reference signal used for the uplink channel, or both.

In some examples, the transmission manager 645 may be configured as or otherwise support a means for receiving, in control signaling and prior to switching to the second beam, a set of power control parameters associated with an uplink channel associated with the second beam. In some examples, the transmission manager 645 may be configured as or otherwise support a means for where determining the communication parameter includes selecting the set of power control parameters.

In some examples, to support determining the communication parameter, the transmission manager 645 may be configured as or otherwise support a means for selecting a default set of power control parameters, a default parameter of a pathloss reference signal, or both.

In some examples, the transmission manager 645 may be configured as or otherwise support a means for selecting a transmission configuration indicator state based on the index of the reference signal, where determining the communication parameter includes selecting a parameter of a pathloss reference signal based on the transmission configuration indicator state.

In some examples, the pathloss reference signal is periodic. In some examples, a first channel of the reference signal has a relationship with a channel of the pathloss reference signal.

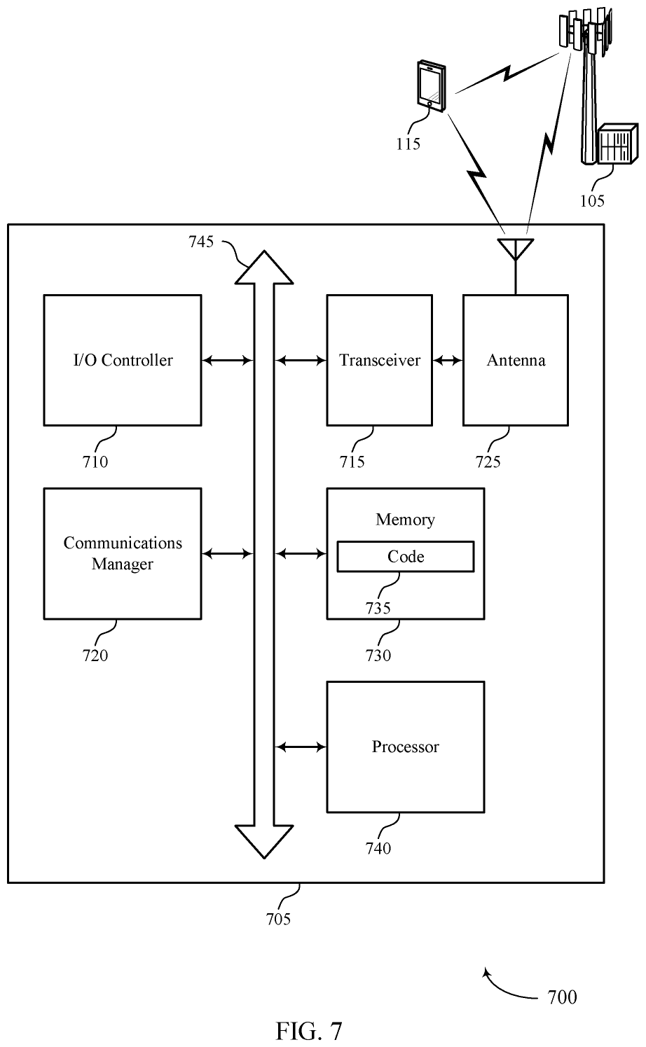

FIG. 7 shows a diagram of a system including a device that supports techniques for determining communication parameters for beam switching in accordance with various aspects of the present disclosure. System 700 may include the device 705, which may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include an antenna 725. However, in some other cases, the device 705 may have more than one antenna, which may be capable of concurrently transmitting or receiving multiple wireless transmissions. The transceiver 715 may communicate bi-directionally, via the one or more antennas, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas for transmission, and to demodulate packets received from the one or more antennas. The transceiver 715, or the transceiver 715 and one or more antennas, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for determining communication parameters for beam switching). For example, the device 705 or a component of the device 705 may include a processor 740 and memory 730 coupled to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for communicating with a base station using a first beam. The communications manager 720 may be configured as or otherwise support a means for transmitting, to the base station, an index of a reference signal associated with a second beam that is different from the first beam. The communications manager 720 may be configured as or otherwise support a means for switching to the second beam to communicate with the base station based on the index of the reference signal. The communications manager 720 may be configured as or otherwise support a means for determining, from the index of the reference signal, a communication parameter associated with the second beam. The communications manager 720 may be configured as or otherwise support a means for communicating, based on the determined communication parameter, with the base station using the second beam.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for determining communication parameters for beam switching as described herein, or the processor 740 and the memory 730 may be otherwise configured to perform or support such operations.

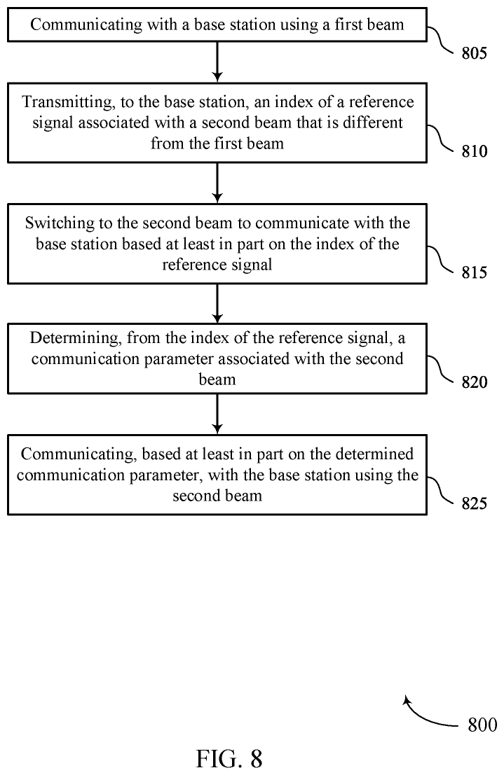

FIG. 8 shows a flowchart illustrating a method that supports techniques for determining communication parameters for beam switching in accordance with various aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include communicating with a base station using a first beam. The operations of 805 may be performed in accordance with examples as disclosed herein. In some examples, aspects of the operations of 805 may be performed by a data manager 625 as described with reference to FIG. 6.

At 810, the method may include transmitting, to the base station, an index of a reference signal associated with a second beam that is different from the first beam. The operations of 810 may be performed in accordance with examples as disclosed herein. In some examples, aspects of the operations of 810 may be performed by a reference signal manager 630 as described with reference to FIG. 6.

At 815, the method may include switching to the second beam to communicate with the base station based on the index of the reference signal. The operations of 815 may be performed in accordance with examples as disclosed herein. In some examples, aspects of the operations of 815 may be performed by a beam manager 635 as described with reference to FIG. 6.

At 820, the method may include determining, from the index of the reference signal, a communication parameter associated with the second beam. The operations of 820 may be performed in accordance with examples as disclosed herein. In some examples, aspects of the operations of 820 may be performed by a data manager 625 as described with reference to FIG. 6.

At 825, the method may include communicating, based on the determined communication parameter, with the base station using the second beam. The operations of 825 may be performed in accordance with examples as disclosed herein. In some examples, aspects of the operations of 825 may be performed by a data manager 625 as described with reference to FIG. 6.

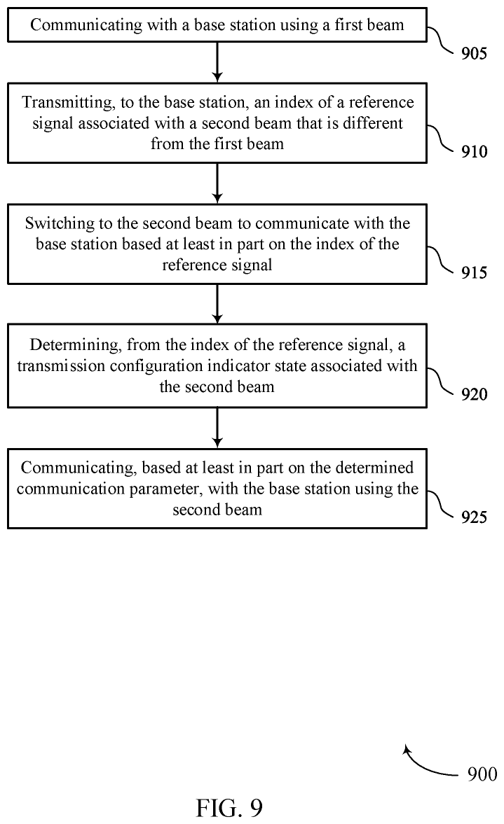

FIG. 9 shows a flowchart illustrating a method that supports techniques for determining communication parameters for beam switching in accordance with various aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include communicating with a base station using a first beam. The operations of 905 may be performed in accordance with examples as disclosed herein. In some examples, aspects of the operations of 905 may be performed by a data manager 625 as described with reference to FIG. 6.

At 910, the method may include transmitting, to the base station, an index of a reference signal associated with a second beam that is different from the first beam. The operations of 910 may be performed in accordance with examples as disclosed herein. In some examples, aspects of the operations of 910 may be performed by a reference signal manager 630 as described with reference to FIG. 6.

At 915, the method may include switching to the second beam to communicate with the base station based on the index of the reference signal. The operations of 915 may be performed in accordance with examples as disclosed herein. In some examples, aspects of the operations of 915 may be performed by a beam manager 635 as described with reference to FIG. 6.

At 920, the method may include determining, from the index of the reference signal, a transmission configuration indicator state associated with the second beam. The operations of 920 may be performed in accordance with examples as disclosed herein. In some examples, aspects of the operations of 920 may be performed by a reception manager 640 as described with reference to FIG. 6.

At 925, the method may include communicating, based on the determined communication parameter, with the base station using the second beam. The operations of 925 may be performed in accordance with examples as disclosed herein. In some examples, aspects of the operations of 925 may be performed by a data manager 625 as described with reference to FIG. 6.

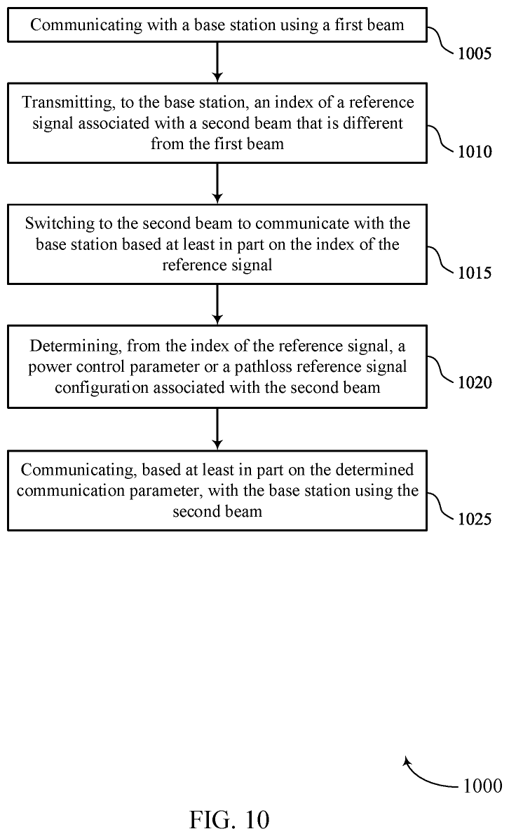

FIG. 10 shows a flowchart illustrating a method that supports techniques for determining communication parameters for beam switching in accordance with various aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include communicating with a base station using a first beam. The operations of 1005 may be performed in accordance with examples as disclosed herein. In some examples, aspects of the operations of 1005 may be performed by a data manager 625 as described with reference to FIG. 6.

At 1010, the method may include transmitting, to the base station, an index of a reference signal associated with a second beam that is different from the first beam. The operations of 1010 may be performed in accordance with examples as disclosed herein. In some examples, aspects of the operations of 1010 may be performed by a reference signal manager 630 as described with reference to FIG. 6.

At 1015, the method may include switching to the second beam to communicate with the base station based on the index of the reference signal. The operations of 1015 may be performed in accordance with examples as disclosed herein. In some examples, aspects of the operations of 1015 may be performed by a beam manager 635 as described with reference to FIG. 6.

At 1020, the method may include determining, from the index of the reference signal, a power control parameter or a pathloss reference signal configuration associated with the second beam. The operations of 1020 may be performed in accordance with examples as disclosed herein. In some examples, aspects of the operations of 1020 may be performed by a transmission manager 645 as described with reference to FIG. 6.

At 1025, the method may include communicating, based on the determined communication parameter, with the base station using the second beam. The operations of 1025 may be performed in accordance with examples as disclosed herein. In some examples, aspects of the operations of 1025 may be performed by a data manager 625 as described with reference to FIG. 6.

The following provides an overview of aspects of the present disclosure:

Aspect 1: A method for wireless communication at a UE, comprising: communicating with a base station using a first beam: transmitting, to the base station, an index of a reference signal associated with a second beam that is different from the first beam: switching to the second beam to communicate with the base station based at least in part on the index of the reference signal: determining, from the index of the reference signal, a communication parameter associated with the second beam: and communicating, based at least in part on the determined communication parameter, with the base station using the second beam.

Aspect 2: The method of aspect 1, further comprising: receiving a message that activates a mode associated with the UE automatically switching to a new beam after indicating the new beam to the base station, wherein the UE switches to the second beam based at least in part on the mode being activated.

Aspect 3: The method of any of aspects 1 through 2, further comprising: receiving, based at least in part on communicating with the base station using the first beam, the reference signal using a transmission configuration indicator state.

Aspect 4: The method of aspect 3, wherein determining the communication parameter comprises: selecting, for receiving downlink communications from the base station, the transmission configuration indicator state used to receive the reference signal.

Aspect 5: The method of aspect 4, further comprising: determining a relationship between a first channel associated with the reference signal and a downlink control channel, a downlink shared channel, a second channel associated with a downlink reference signal, or any combination thereof, the relationship being based at least in part on common time and frequency characteristics, common spatial characteristics, or both.

Aspect 6: The method of any of aspects 1 through 2, wherein determining the communication parameter comprises: selecting a transmission configuration indicator state of the reference signal that indicates a spatial relationship between a first channel associated with the reference signal and a downlink control channel, a downlink shared channel, a second channel associated with a downlink reference signal, or any combination thereof.

Aspect 7: The method of aspect 6, further comprising: determining that a plurality of transmission configuration indicator states of the reference signal indicate the spatial relationship: and selecting the transmission configuration indicator state based at least in part on an index of the transmission configuration indicator state.

Aspect 8: The method of any of aspects 1 through 2, wherein determining the communication parameter comprises: selecting a transmission configuration indicator state of a second reference signal that indicates a spatial relationship between a first channel associated with the reference signal and a second channel associated with the second reference signal.

Aspect 9: The method of aspect 8, further comprising: determining that a plurality of transmission configuration indicator states of the second reference signal indicate the spatial relationship: and selecting the transmission configuration indicator state based at least in part on an index of the transmission configuration indicator state.

Aspect 10: The method of any of aspects 1 through 2, wherein determining the communication parameter comprises: determining a spatial relationship between a first channel of the reference signal and a downlink control channel, a downlink shared channel, a second channel associated with a downlink reference signal, or any combination thereof.

Aspect 11: The method of aspect 10, wherein determining the communication parameter comprises: determining a relationship between the first channel of the reference signal and a third channel of a synchronization and signal block: and determining a time and frequency relationship between the third channel of the synchronization and signal block and the downlink control channel, the downlink shared channel, the second channel associated with the downlink reference signal, or any combination thereof.

Aspect 12: The method of aspect 10, wherein determining the communication parameter comprises: determining a relationship between the first channel of the reference signal and a third channel of a periodic channel state information reference signal: and determining a time and frequency relationship between the third channel of the periodic channel state information reference signal and the downlink control channel, the downlink shared channel, the second channel associated with the downlink reference signal, or any combination thereof.

Aspect 13: The method of any of aspects 1 through 12, wherein the second beam is a downlink beam.

Aspect 14: The method of any of aspects 1 through 13, wherein determining the communication parameter comprises: selecting a latest set of power control parameters used for an uplink channel associated with the second beam, a latest parameter of pathloss reference signal used for the uplink channel, or both.

Aspect 15: The method of any of aspects 1 through 13, further comprising: receiving, in control signaling and prior to switching to the second beam, a set of power control parameters associated with an uplink channel associated with the second beam, wherein determining the communication parameter comprises selecting the set of power control parameters.

Aspect 16: The method of any of aspects 1 through 13, wherein determining the communication parameter comprises: selecting a default set of power control parameters, a default parameter of a pathloss reference signal, or both.

Aspect 17: The method of any of aspects 1 through 13, further comprising: selecting a transmission configuration indicator state based at least in part on the index of the reference signal, wherein determining the communication parameter comprises selecting a parameter of a pathloss reference signal based at least in part on the transmission configuration indicator state.

Aspect 18: The method of aspect 17, wherein the pathloss reference signal is periodic, and a first channel of the reference signal has a relationship with a channel of the pathloss reference signal.

Aspect 19: The method of any of aspects 1 through 18, wherein the second beam is an uplink beam.

Aspect 20: The method of any of aspects 1 through 19, wherein determining the communication parameter comprises: determining a transmission configuration indicator state based at least in part on the reference signal.

Aspect 21: The method of any of aspects 1 through 20, wherein determining the communication parameter comprises: determining a power control parameter or pathloss reference signal configuration based at least in part on the reference signal.

Aspect 22: An apparatus for wireless communication at a UE, comprising a processor: memory coupled with the processor; and instructions stored in the memory and executable by the processor to cause the apparatus to perform a method of any of aspects 1 through 21.

Aspect 23: An apparatus for wireless communication at a UE, comprising at least one means for performing a method of any of aspects 1 through 21.

Aspect 24: A non-transitory computer-readable medium storing code for wireless communication at a UE, the code comprising instructions executable by a processor to perform a method of any of aspects 1 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
communicating with a base station using a first beam;
transmitting, to the base station, an index of a reference signal associated with a second beam that is different from the first beam;
switching to the second beam to communicate with the base station based at least in part on the index of the reference signal;
determining, from the index of the reference signal, a communication parameter associated with the second beam; and
communicating, based at least in part on the determined communication parameter, with the base station using the second beam.

2. The method of claim 1, further comprising:
receiving a message that activates a mode associated with the UE automatically switching to a new beam after indicating the new beam to the base station, wherein the UE switches to the second beam based at least in part on the mode being activated.

3. The method of claim 1, further comprising:
receiving, based at least in part on communicating with the base station using the first beam, the reference signal using a transmission configuration indicator state.

4. The method of claim 3, wherein determining the communication parameter comprises:
selecting, for receiving downlink communications from the base station, the transmission configuration indicator state used to receive the reference signal.

5. The method of claim 4, further comprising:
determining a relationship between a first channel associated with the reference signal and a downlink control channel, a downlink shared channel, a second channel associated with a downlink reference signal, or any combination thereof, the relationship being based at least in part on common time and frequency characteristics, common spatial characteristics, or both.

6. The method of claim 1, wherein determining the communication parameter comprises:
selecting a transmission configuration indicator state of the reference signal that indicates a spatial relationship between a first channel associated with the reference signal and a downlink control channel, a downlink shared channel, a second channel associated with a downlink reference signal, or any combination thereof.

7. The method of claim 6, further comprising:
determining that a plurality of transmission configuration indicator states of the reference signal indicate the spatial relationship; and
selecting the transmission configuration indicator state based at least in part on an index of the transmission configuration indicator state.

8. The method of claim 1, wherein determining the communication parameter comprises:
selecting a transmission configuration indicator state of a second reference signal that indicates a spatial relationship between a first channel associated with the reference signal and a second channel associated with the second reference signal.

9. The method of claim 8, further comprising:
determining that a plurality of transmission configuration indicator states of the second reference signal indicate the spatial relationship; and
selecting the transmission configuration indicator state based at least in part on an index of the transmission configuration indicator state.

10. The method of claim 1, wherein determining the communication parameter comprises:
determining a spatial relationship between a first channel of the reference signal and a downlink control channel, a downlink shared channel, a second channel associated with a downlink reference signal, or any combination thereof.

11. The method of claim 10, wherein determining the communication parameter comprises:
determining a relationship between the first channel of the reference signal and a third channel of a synchronization signal block; and
determining a time and frequency relationship between the third channel of the synchronization signal block and the downlink control channel, the downlink shared channel, the second channel associated with the downlink reference signal, or any combination thereof.

12. The method of claim 10, wherein determining the communication parameter comprises:
determining a relationship between the first channel of the reference signal and a third channel of a periodic channel state information reference signal; and
determining a time and frequency relationship between the third channel of the periodic channel state information reference signal and the downlink control channel, the downlink shared channel, the second channel associated with the downlink reference signal, or any combination thereof.

13. The method of claim 1, wherein the second beam is a downlink beam.

14. The method of claim 1, wherein determining the communication parameter comprises:
selecting a latest set of power control parameters used for an uplink channel associated with the second beam, a latest parameter of pathloss reference signal used for the uplink channel, or both.

15. The method of claim 1, further comprising:
receiving, in control signaling and prior to switching to the second beam, a set of power control parameters associated with an uplink channel associated with the second beam,
wherein determining the communication parameter comprises selecting the set of power control parameters.

16. The method of claim 1, wherein determining the communication parameter comprises:
selecting a default set of power control parameters, a default parameter of a pathloss reference signal, or both.

17. The method of claim 1, further comprising:
selecting a transmission configuration indicator state based at least in part on the index of the reference signal,
wherein determining the communication parameter comprises selecting a parameter of a pathloss reference signal based at least in part on the transmission configuration indicator state.

18. The method of claim 17, wherein the pathloss reference signal is periodic, and wherein a first channel of the reference signal has a relationship with a channel of the pathloss reference signal.

19. The method of claim 1, wherein the second beam is an uplink beam.

20. An apparatus for wireless communication at a user equipment (UE), comprising:
a processor;
memory coupled with the processor; and
instructions stored in the memory and executable by the processor to cause the apparatus to:
communicate with a base station using a first beam;
transmit, to the base station, an index of a reference signal associated with a second beam that is different from the first beam;
switch to the second beam to communicate with the base station based at least in part on the index of the reference signal;
determine, from the index of the reference signal, a communication parameter associated with the second beam; and
communicate, based at least in part on the determined communication parameter, with the base station using the second beam.

21. The apparatus of claim 20, wherein the instructions are further executable by the processor to cause the apparatus to:
receive, based at least in part on communicating with the base station using the first beam, the reference signal using a transmission configuration indicator state.

22. The apparatus of claim 21, wherein the instructions to determine the communication parameter are executable by the processor to cause the apparatus to:
selecting, for receive downlink communications from the base station, the transmission configuration indicator state used to receive the reference signal.

23. The apparatus of claim 22, wherein the instructions are further executable by the processor to cause the apparatus to:
determine a relationship between a first channel associated with the reference signal and a downlink control channel, a downlink shared channel, a second channel associated with a downlink reference signal, or any combination thereof, the relationship being based at least in part on common time and frequency characteristics, common spatial characteristics, or both.

24. The apparatus of claim 20, wherein the instructions to determine the communication parameter are executable by the processor to cause the apparatus to:
select a transmission configuration indicator state of the reference signal that indicates a spatial relationship between a first channel associated with the reference signal and a downlink control channel, a downlink shared channel, a second channel associated with a downlink reference signal, or any combination thereof.

25. The apparatus of claim 24, wherein the instructions are further executable by the processor to cause the apparatus to:
determine that a plurality of transmission configuration indicator states of the reference signal indicate the spatial relationship; and
select the transmission configuration indicator state based at least in part on an index of the transmission configuration indicator state.

26. The apparatus of claim 20, wherein the instructions to determine the communication parameter are executable by the processor to cause the apparatus to:
select a transmission configuration indicator state of a second reference signal that indicates a spatial relationship between a first channel associated with the reference signal and a second channel associated with the second reference signal.

27. The apparatus of claim 26, wherein the instructions are further executable by the processor to cause the apparatus to:
determine that a plurality of transmission configuration indicator states of the second reference signal indicate the spatial relationship; and
select the transmission configuration indicator state based at least in part on an index of the transmission configuration indicator state.

28. The apparatus of claim 20, wherein the instructions to determine the communication parameter are executable by the processor to cause the apparatus to:
determine a spatial relationship between a first channel of the reference signal and a downlink control channel, a downlink shared channel, a second channel associated with a downlink reference signal, or any combination thereof.

29. An apparatus for wireless communication at a user equipment (UE), comprising:
means for communicating with a base station using a first beam;
means for transmitting, to the base station, an index of a reference signal associated with a second beam that is different from the first beam;
means for switching to the second beam to communicate with the base station based at least in part on the index of the reference signal;
means for determining, from the index of the reference signal, a communication parameter associated with the second beam; and
means for communicating, based at least in part on the determined communication parameter, with the base station using the second beam.

30. A non-transitory computer-readable medium storing code for wireless communication at a user equipment (UE), the code comprising instructions executable by a processor to:
communicate with a base station using a first beam;
transmit, to the base station, an index of a reference signal associated with a second beam that is different from the first beam;
switch to the second beam to communicate with the base station based at least in part on the index of the reference signal;
determine, from the index of the reference signal, a communication parameter associated with the second beam; and
communicate, based at least in part on the determined communication parameter, with the base station using the second beam.
